(19) United States
(12) Patent Application Publication
(10) Pub. No.: US 2026/0302644 A1
(43) Pub. Date: Oct. 1, 2026

(54) DUAL-BAND YAGI ANTENNA AND METHOD OF MANUFACTURING THE SAME

(71) Applicant: Roush Design & Consulting, LLC, West End, NC (US)

(72) Inventor: Randy ROUSH, West End, NC (US)

(21) Appl. No.: 19/092,173

(22) Filed: Mar. 27, 2025

(51) Int. Cl. H01Q 19/30; H01Q 5/378; H01Q 5/50

(52) U.S. Cl. CPC H01Q 19/30; H01Q 5/378; H01Q 5/50

(57) ABSTRACT

A dual-band Yagi antenna is provided. The dual-band Yagi antenna may include a low-frequency (LF) boom having a plurality of PCB mounting pads configured to receive low-frequency (LF) elements, a plurality of LF elements positioned on the PCB mounting pads of the LF boom, a high-frequency (HF) boom disposed relative to the LF boom and having a plurality of mounting holes, a plurality of HF elements inserted through the mounting holes in the HF boom, and a folded dipole driven element configured to enhance antenna bandwidth.

### TECHNICAL FIELD

The present disclosure relates generally to Yagi-Uda antennas, and more specifically to a dual-band Yagi-Uda antenna system with improved bandwidth performance and a method of manufacturing the same.

### SUMMARY

According to an aspect of one or more examples, there is provided a dual-band Yagi antenna. The dual-band Yagi antenna may include a low-frequency (LF) boom having a plurality of PCB mounting pads configured to receive low-frequency (LF) elements, a plurality of LF elements positioned on the PCB mounting pads of the LF boom, a high-frequency (HF) boom disposed relative to the LF boom and having a plurality of mounting holes, a plurality of HF elements inserted through the mounting holes in the HF boom, and a folded dipole driven element configured to enhance antenna bandwidth. The LF elements and HF elements may be configured to operate at approximately 2.4 GHz and 5.8 GHz, respectively. The HF elements may be secured within the mounting holes using solder pads disposed around the holes to ensure stable electrical contact and mechanical support. The LF elements may be secured to the PCB mounting pads using a low-temperature soldering process, preventing reflow of previously soldered HF elements. The HF elements may be secured using a high-temperature soldering process, allowing sequential soldering of HF and LF elements. The HF boom may be positioned at a non-central mounting offset relative to the LF boom, facilitating efficient manufacturing while maintaining performance. The LF elements and HF elements may be cut to predefined lengths based on resonant slot length parameters to enhance radiation efficiency. The dual-band Yagi antenna may include an assembly jig configured to precisely align the HF elements within the HF boom before soldering. The folded dipole driven element may be configured to provide impedance matching across dual frequency bands, reducing reflection losses. The dual-band Yagi antenna may include a housing formed from an RF-transparent material, configured to enclose at least a portion of the LF boom, HF boom, and associated elements.

According to an aspect of one or more examples, there is provided a method for manufacturing a dual-band Yagi antenna. The method may include providing a low-frequency (LF) boom having a plurality of PCB mounting pads, placing a plurality of low-frequency (LF) elements onto the PCB mounting pads, providing a high-frequency (HF) boom having a plurality of mounting holes, inserting a plurality of high-frequency (HF) elements through the mounting holes, and securing a folded dipole driven element to enhance antenna bandwidth. The LF elements and HF elements may be configured to operate at approximately 2.4 GHz and 5.8 GHz, respectively. The method may include securing the HF elements within the mounting holes using solder pads disposed around the holes. The method may include securing the LF elements to the PCB mounting pads using a low-temperature soldering process. The method may include securing the HF elements using a high-temperature soldering process, allowing sequential soldering of HF and LF elements. The method may include positioning the HF boom at a non-central mounting offset relative to the LF boom. The method may include using an assembly jig to align the HF elements within the HF boom before soldering. The method may include cutting the LF elements and HF elements to predefined lengths based on resonant slot length parameters. The method may include enclosing at least a portion of the LF boom, HF boom, and associated elements within an RF-transparent housing. The method may include performing a batch soldering process, wherein the HF elements are secured in a first oven pass at a high temperature and the LF elements are secured in a second oven pass at a lower temperature.

### BRIEF DESCRIPTION OF DRAWINGS

FIG. 1A shows a perspective view of a dual-band Yagi antenna according to various examples.

FIG. 1B shows a perspective view of an alternative dual-band Yagi antenna according to various examples.

FIG. 2A shows an enlarged view of an offset mounting configuration for high-frequency (HF) elements within a dual-band Yagi antenna according to various examples.

FIG. 2B shows an enlarged view of low-frequency (LF) element placement within a dual-band Yagi antenna according to various examples.

FIG. 3A shows an assembly jig configured to assist in the precise alignment of high-frequency (HF) elements within a dual-band Yagi antenna according to various examples.

FIG. 3B shows an assembly jig configured to assist in the precise alignment of low-frequency (LF) elements onto PCB mounting pads of a low-frequency (LF) boom within a dual-band Yagi antenna according to various examples.

FIG. 4 shows a flowchart of a method for manufacturing a dual-band Yagi antenna according to various examples.

### DETAILED DESCRIPTION OF VARIOUS EXAMPLES

Reference will now be made in detail to the following various examples, which are illustrated in the accompanying drawings, wherein like reference numerals refer to like elements throughout. The following examples may be embodied in various forms without being limited to the examples set forth herein.

Yagi-Uda antennas are widely used in wireless communication systems due to their high gain and directional characteristics. These antennas consist of a driven element, one or more parasitic elements, such as directors and reflectors, and a boom that structurally supports the elements. The Yagi-Uda design enables efficient signal reception and transmission, making it suitable for applications such as television broadcasting, amateur radio, and wireless networking.

With the increasing demand for multi-band wireless communication, dual-band Yagi-Uda antennas have been developed to support multiple frequency bands within a single structure. These antennas enable operation at different frequencies, reducing the need for multiple separate antennas and improving system efficiency. Dual-band Yagi-Uda designs are particularly beneficial for modern wireless applications, including Wi-Fi, which operates at both 2.4 GHz and 5.8 GHz frequency bands, as well as for emerging Internet of Things (IoT) and vehicular communication systems.

However, existing dual-band Yagi-Uda antennas often face challenges related to manufacturing complexity, element placement, and signal interference between different frequency bands. Many conventional designs require intricate assembly techniques, precise alignment of elements, and additional structural components to maintain performance across both frequency bands. Additionally, ensuring consistent element spacing and secure attachment methods can be difficult, leading to variations in antenna performance.

Therefore, there is a need for an improved dual-band Yagi-Uda antenna that simplifies manufacturing, ensures reliable performance, and effectively supports multiple frequency bands.

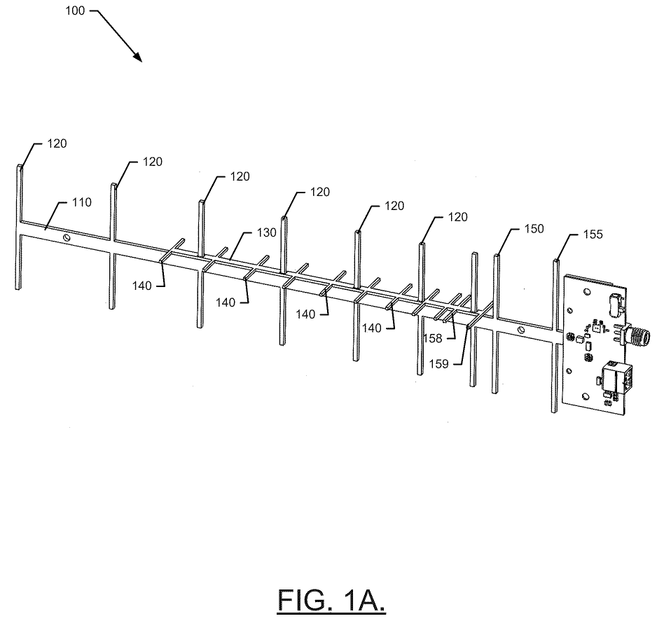

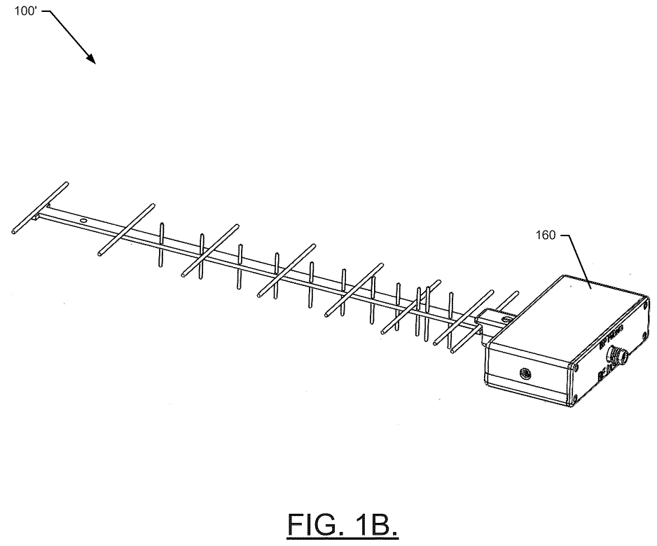

FIG. 1A shows a perspective view of a dual-band Yagi antenna 100 according to various examples. The dual-band Yagi antenna 100 may be configured to operate over two distinct frequency bands (e.g., 2.4 GHz and 5.8 GHz), providing high gain and directional transmission characteristics suitable for various wireless communication applications. The dual-band Yagi antenna 100 may include a low-frequency (LF) boom 110, a plurality of LF elements 120, a high-frequency (HF) boom 130, a plurality of HF elements 140, a folded dipole driven element 150, and a housing 160 for signal transmission and reception.

In certain embodiments, the dual-band Yagi antenna 100 may incorporate a low-frequency (LF) boom 110, which serves as the structural foundation for supporting multiple antenna elements. The LF boom 110 may be designed as a printed circuit board (PCB) with conductive traces on both the top and bottom surfaces. These traces may be interconnected using closely spaced plated-through holes or stitched vias to maintain electrical continuity and improve structural integrity. The LF boom 110 may include designated PCB mounting pads that facilitate the precise placement and secure attachment of various antenna components. In some implementations, the LF boom 110 may be fabricated from lightweight dielectric materials to enhance mechanical stability while reducing signal interference. Additionally, the LF boom 110 may be configured with pre-defined slots or holes to accommodate high-frequency (HF) elements 140, ensuring consistent and repeatable placement for enhanced manufacturing efficiency. The lightweight construction, coupled with the nesting of two antennas within a single structure also provides for low wind-drag, which makes example embodiments particularly useful for applications with small aircraft (e.g., drones).

The high-frequency (HF) boom 130 may be positioned in alignment with or at an angle relative to the LF boom 110, depending on the specific design of the dual-band Yagi antenna 100. In one configuration, the HF boom 130 may include precisely formed holes through which the high-frequency (HF) elements 140 are inserted and secured using solder pads disposed around the mounting holes. This off-center mounting approach can streamline the manufacturing process while preserving the intended electromagnetic performance of the dual-band Yagi antenna 100. The HF elements 140 may be cut to specific lengths based on the resonant slot length, ensuring consistent performance across multiple production units. In some implementations, the HF boom 130 may be assembled using aluminum jigs to facilitate the application of high-temperature solder paste before undergoing a controlled reflow process in an oven. This assembly method allows for secure attachment of the HF elements 140 while preventing displacement during subsequent manufacturing steps.

To support dual-band operation, the dual-band Yagi antenna 100 may further comprise a plurality of low-frequency (LF) elements 120, which may be positioned directly on the PCB mounting pads of the LF boom 110. These LF elements 120 may be soldered to the PCB surface and cut to a predefined length to achieve better signal transmission characteristics. The LF elements 120 may be fabricated from conductive materials such as copper or aluminum to ensure efficient signal propagation. In some implementations, the LF elements 120 may be arranged in conjunction with the HF elements 140 to form an interleaved Yagi antenna array. This arrangement allows for efficient dual-band operation while maintaining a compact footprint. The LF elements 120 may be secured using a secondary soldering process at a lower temperature than that used for the HF elements 140, ensuring that the HF elements remain in place during the final assembly phase.

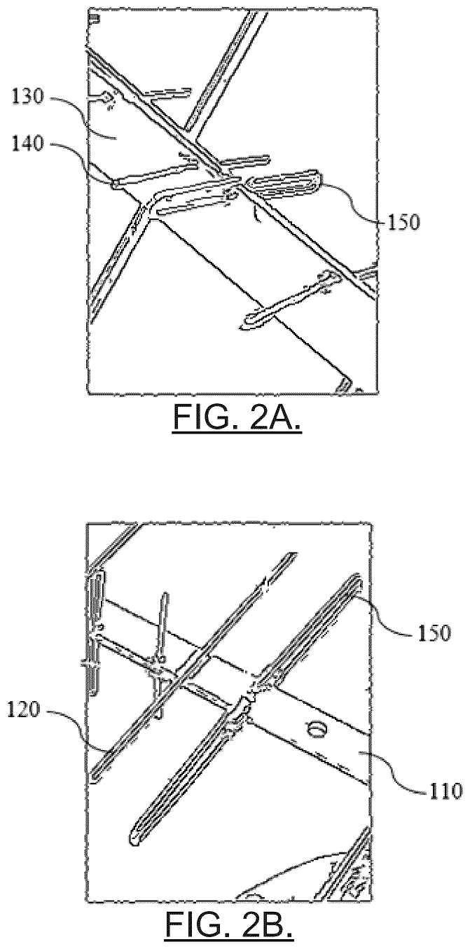

The dual-band Yagi antenna 100 may further incorporate a driven element 150, which is a folded dipole driven element (see FIG. 2A below) in some cases that is designed to enhance bandwidth and impedance matching. The driven element 150 may be located between the LF elements 120, which act as directors, and a reflector 155. The driven element 150 may be configured to function with both the LF and HF Yagi arrays, contributing to broader frequency response characteristics. However, the HF Yagi array may have a driven element 158 and reflector 159 that operate similarly to those of the LF Yagi array. In some embodiments, the driven element 150 may be soldered at one end, folded behind the LF boom 110, and then soldered at the opposite end. This configuration can enhance signal reception and transmission by maintaining a balanced impedance across the frequency spectrum. The use of a folded dipole structure can also improve radiation efficiency by reducing mismatch losses and enhancing overall gain.

In some alternatives, the HF and LF elements may be soldered to the respective booms. FIG. 1B illustrates such an example as dual-band Yagi antenna 100'. To protect the antenna components and ensure reliable operation in various environmental conditions, the dual-band Yagi antenna 100′ may include a housing 160. The housing 160 may be constructed from RF-transparent materials such as polymer composites or PCB-based substrates to reduce signal attenuation while providing mechanical support. In some implementations, the housing 160 may incorporate mounting points or fasteners to secure the antenna assembly to a vehicle, mast, or other deployment structures. Additionally, the housing 160 may include integrated features for heat dissipation, ensuring stable performance under extended operating conditions. The overall design of the housing 160 may be tailored to meet specific application requirements, such as vehicular mounting for low wind-drag operation or compact enclosures for space-constrained installations.

FIG. 2A shows an enlarged view of the offset mounting configuration for the high-frequency (HF) elements 140 within the dual-band Yagi antenna 100 according to various examples. The HF elements 140 may be inserted through designated mounting holes within the high-frequency (HF) boom 130, ensuring precise alignment for optimal signal transmission. The mounting holes may be strategically placed to facilitate a slight off-center positioning of the HF elements 140 relative to the low-frequency (LF) boom 110, which may enhance the manufacturability of the antenna while maintaining performance characteristics. In some implementations, solder pads may be disposed around the mounting holes, allowing the HF elements 140 to be secured using a high-temperature soldering process. This method ensures a robust mechanical and electrical connection while streamlining assembly. Additionally, the enlarged view in FIG. 2A may depict optional support structures or alignment guides that further enhance the uniformity and repeatability of the HF element placement. By implementing this offset mounting technique, the dual-band Yagi antenna 100 may achieve improved manufacturability without negatively impacting the antenna's frequency response or radiation pattern.

FIG. 2B shows an enlarged view of low-frequency (LF) element 120 placement within the dual-band Yagi antenna 100 according to various examples. As shown in FIG. 2B, the LF elements 120 may be positioned directly onto PCB mounting pads disposed along the low-frequency (LF) boom 110 of the dual-band Yagi antenna 100. The LF elements 120 may be secured using a lower-temperature soldering process, which ensures reliable attachment while preventing damage to previously installed high-frequency components. In some embodiments, the LF elements 120 may be cut to precise lengths to achieve the desired operational characteristics. The enlarged view further illustrates how each LF element 120 may be placed on corresponding solder pads, enabling consistent and repeatable positioning. Additionally, the PCB mounting pads may be electrically interconnected with traces on both the top and bottom surfaces of the LF boom 110, with plated-through holes or stitched vias providing enhanced conductivity. This configuration allows the LF elements 120 to efficiently propagate signals while maintaining a compact form factor. In certain implementations, alignment jigs or templates may be utilized to facilitate precise LF element placement, ensuring that each element is positioned according to predefined specifications.

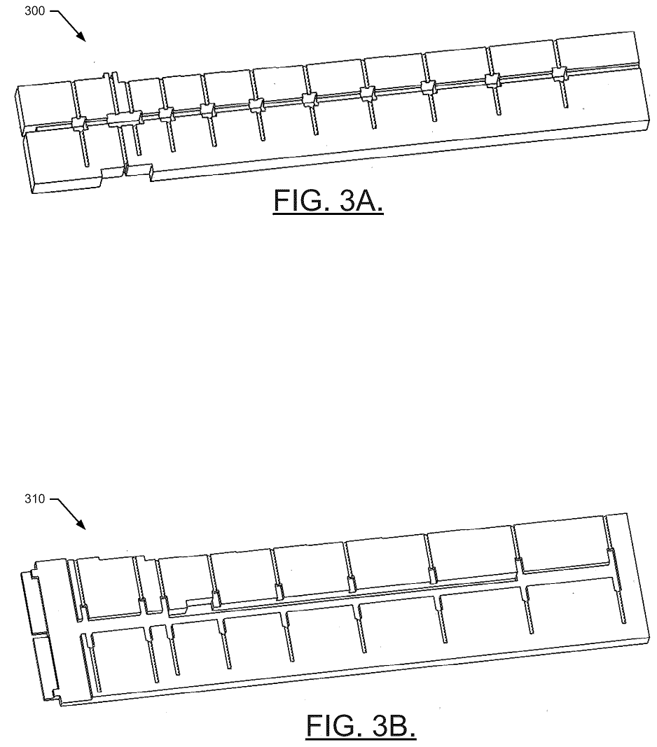

FIG. 3A shows an assembly jig 300 configured to assist in the precise alignment of the high-frequency (HF) elements 140 within the dual-band Yagi antenna 100 according to various examples. In some implementations, the jig 300 may be constructed from aluminum or other thermally stable materials capable of withstanding the soldering process. The jig 300 may include pre-formed slots, grooves, or guides that hold the HF elements 140 in place while high-temperature solder paste is applied to the mounting holes in the high-frequency (HF) boom 130. The entire assembly, including the HF boom 130 and the secured HF elements 140, may then be placed in a reflow oven, where the solder melts and forms a durable electrical and mechanical connection. This method helps ensure uniform element positioning, reducing manufacturing variability and improving antenna performance. The jig 300 may also be designed to accommodate multiple antenna assemblies simultaneously, enabling efficient batch processing. Additionally, the jig 300 may feature adjustable fixtures or clamping mechanisms that allow for fine-tuned alignment, ensuring that each HF element 140 is consistently positioned in accordance with the design specifications.

FIG. 3B shows an assembly jig 310 configured to assist in the precise alignment of the low-frequency (LF) elements 120 onto the PCB mounting pads of the low-frequency (LF) boom 110 within the dual-band Yagi antenna 100 according to various examples. The jig 310 may incorporate custom recesses, guides, or fixtures to hold the LF elements 120 in place while a lower-temperature soldering process is performed. This ensures that the LF elements 120 are reliably affixed to the PCB mounting pads without disturbing the previously soldered high-frequency components. In some implementations, the jig 310 may facilitate a two-step assembly process, where the high-frequency (HF) elements 140 are first secured using high-temperature solder, followed by the LF elements 120, which are affixed at a lower temperature to prevent reflow of the HF element connections. The assembly jig 310 depicted in FIG. 3B may also include alignment reference marks or mechanical stops to ensure that each LF element 120 is positioned according to predefined design parameters. By utilizing this jig-assisted placement method, the dual-band Yagi antenna 100 can achieve high manufacturing precision, improved performance consistency, and reduced assembly time.

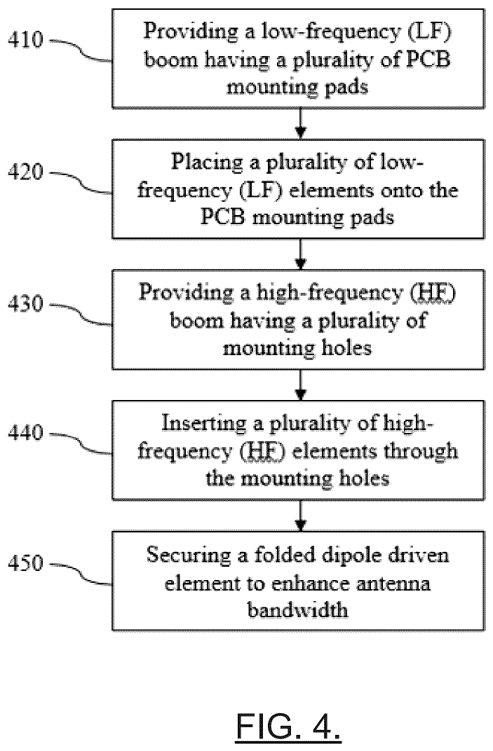

FIG. 4 shows a flowchart 400 of a method for manufacturing a dual-band Yagi antenna according to various examples. At operation 410, the method may include providing a low-frequency (LF) boom having a plurality of PCB mounting pads. At operation 420, the method may include placing a plurality of low-frequency (LF) elements onto the PCB mounting pads. At operation 430, the method may include providing a high-frequency (HF) boom having a plurality of mounting holes. At operation 440, the method may include inserting a plurality of high-frequency (HF) elements through the mounting holes. At operation 450, the method may include securing a folded dipole driven element to enhance antenna bandwidth.

It may be noted that the flowchart 400 is explained to have above stated operations; however, those skilled in the art would appreciate that the flowchart 400 may have more/less number of operations, which may enable all the above stated examples of the present disclosure.

Various examples have been disclosed herein, in connection with the above description and the drawings. It will be understood that it would be unduly repetitious to literally describe and illustrate every combination and subcombination of these examples. Accordingly, all examples can be combined in any way or combination, and the present specification, including the drawings, shall be construed to constitute a complete written description of all combinations and subcombinations of the examples described herein, and of the manner and process of making and using them, and shall support claims to any such combination or subcombination.

It will be appreciated by persons skilled in the art that the examples described herein are not limited to what has been particularly shown and described herein above. In addition, unless mention was made above to the contrary, it should be noted that all of the accompanying drawings are not to scale. A variety of modifications and variations are possible in light of the above teachings.

What is claimed is:

1. A dual-band Yagi antenna, comprising:
a low-frequency (LF) boom having a plurality of PCB mounting pads configured to receive low-frequency (LF) elements;
a plurality of LF elements positioned on the PCB mounting pads of the LF boom;
a high-frequency (HF) boom disposed relative to the LF boom and having a plurality of mounting holes;
a plurality of HF elements inserted through the mounting holes in the HF boom; and
a folded dipole driven element configured to enhance antenna bandwidth.

2. The dual-band Yagi antenna of claim 1, wherein the LF elements and HF elements are configured to operate at approximately 2.4 GHz and 5.8 GHz, respectively.

3. The dual-band Yagi antenna of claim 1, wherein the HF elements are secured within the mounting holes using solder pads disposed around the holes to ensure stable electrical contact and mechanical support.

4. The dual-band Yagi antenna of claim 1, wherein the LF elements are secured to the PCB mounting pads using a low-temperature soldering process, preventing reflow of previously soldered HF elements.

5. The dual-band Yagi antenna of claim 1, wherein the HF elements are secured using a high-temperature soldering process, allowing sequential soldering of HF and LF elements.

6. The dual-band Yagi antenna of claim 1, wherein the HF boom is positioned at a non-central mounting offset relative to the LF boom, facilitating efficient manufacturing while maintaining performance.

7. The dual-band Yagi antenna of claim 1, wherein the LF elements and HF elements are cut to predefined lengths based on resonant slot length parameters to enhance radiation efficiency.

8. The dual-band Yagi antenna of claim 1, further comprising an assembly jig configured to precisely align the HF elements within the HF boom before soldering.

9. The dual-band Yagi antenna of claim 1, wherein the folded dipole driven element is configured to provide impedance matching across dual frequency bands, reducing reflection losses.

10. The dual-band Yagi antenna of claim 1, further comprising a housing formed from an RF-transparent material, configured to enclose at least a portion of the LF boom, HF boom, and associated elements.

11. A method for assembling a dual-band Yagi antenna, the method comprising:
providing a low-frequency (LF) boom having a plurality of PCB mounting pads;
placing a plurality of low-frequency (LF) elements onto the PCB mounting pads;
providing a high-frequency (HF) boom having a plurality of mounting holes;
inserting a plurality of high-frequency (HF) elements through the mounting holes; and
securing a folded dipole driven element to enhance antenna bandwidth.

12. The method of claim 11, wherein the LF elements and HF elements are configured to operate at approximately 2.4 GHz and 5.8 GHz, respectively.

13. The method of claim 11, further comprising securing the HF elements within the mounting holes using solder pads disposed around the holes.

14. The method of claim 11, further comprising securing the LF elements to the PCB mounting pads using a low-temperature soldering process.

15. The method of claim 11, further comprising securing the HF elements using a high-temperature soldering process, allowing sequential soldering of HF and LF elements.

16. The method of claim 11, further comprising positioning the HF boom at a non-central mounting offset relative to the LF boom.

17. The method of claim 11, further comprising using an assembly jig to align the HF elements within the HF boom before soldering.

18. The method of claim 11, further comprising cutting the LF elements and HF elements to predefined lengths based on resonant slot length parameters.

19. The method of claim 11, further comprising enclosing at least a portion of the LF boom, HF boom, and associated elements within an RF-transparent housing.

20. The method of claim 11, further comprising performing a batch soldering process, wherein the HF elements are secured in a first oven pass at a high temperature and the LF elements are secured in a second oven pass at a lower temperature.
